(19) United States
(12) Patent Application Publication
(10) Pub. No.: US 2026/0116727 A1
(43) Pub. Date: Apr. 30, 2026

(54) LIFT DEVICE WITH IMAGE-BASED RECOGNITION OF OPERATOR STATUS

(71) Applicant: Oshkosh Corporation, Oshkosh, WI (US)

(72) Inventor: Prabhu Shankar, Oshkosh, WI (US)

(73) Assignee: Oshkosh Corporation, Oshkosh, WI (US)

(21) Appl. No.: 19/086,258

(22) Filed: Mar. 21, 2025

Related U.S. Application Data
(60) Provisional application No. 63/712,642, filed on Oct. 28, 2024.

(51) Int. Cl. B66F 17/00

(52) U.S. Cl. CPC B66F 17/00; B66F 17/006; B66F 17/003

(57) ABSTRACT

Systems and methods for operating a lift device are described herein. The lift device having a chassis, a platform configured to support a user, a lift assembly coupling the platform to the chassis, an actuator, a camera having a field of view and coupled to the platform, and a controller. The actuator is configured to perform at least one of (a) moving the platform relative to the chassis, or (b) propelling the chassis. The controller is configured to receive, from the camera, image data indicative of the field of view of the camera and determine that a portion of the user extends within a predetermined area of the field of view of the camera. The controller is further configured to operate the actuator in response to determining that the portion of the user extends within the predetermined area.

### CROSS-REFERENCE TO RELATED APPLICATIONS

This U.S. patent application claims the benefit and priority to U.S. Provisional Patent Application No. 63/712,642 , filed Oct. 28, 2024, the entire contents of which is hereby incorporated herein by reference.

### BACKGROUND

The present disclosure relates generally to the field of lift devices and other user-operated industrial equipment. More specifically, the present disclosure relates to control systems for lift devices and other user-operated industrial equipment.

### SUMMARY

One embodiment of the present disclosure relates to a lift device having a chassis, a platform configured to support a user, a lift assembly coupling the platform to the chassis, an actuator, a camera having a field of view and coupled to the platform, and a controller. The actuator is configured to perform at least one of (a) moving the platform relative to the chassis or (b) propelling the chassis. The controller is configured to receive, from the camera, image data indicative of the field of view of the camera and determine that a portion of the user extends within a predetermined area of the field of view of the camera. The controller is further configured to operate the actuator in response to determining that the portion of the user extends within the predetermined area.

Another embodiment relates to a control system for user-operated industrial equipment. The control system includes a camera coupled to the user-operated industrial equipment and a controller communicatively coupled to the camera. The controller is configured to receive one or more operator conditions and to receive, from the camera, visual data indicative of the one or more operator conditions. The controller is configured to determine, based on the visual data, whether each of the one or more operator conditions are met. In response to determining that at least one of the one or more operator conditions are not met, the controller inhibits operation of the industrial equipment. In response to determining that each of the one or more operator conditions are met, the controller permits regular operation of the industrial equipment.

Yet another embodiment relates to a method of controlling a lift device. The method includes providing a camera having a field of view and coupled to a platform of a lift device, the platform configured to support a user. The method further includes receiving, from the camera, image data indicative of the field of view of the camera, determining that a portion of the user extends within a predetermined area of the field of view of the camera, and operating the lift device in response to determining that the portion of the user extends within the predetermined area.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a front perspective view of a boom lift, according to an exemplary embodiment;

FIG. 2 is a top perspective view of a base assembly of the boom lift of FIG. 1, with a turntable removed;

FIG. 3 is a top perspective view of a portion of the base assembly of FIG. 2;

FIG. 4 is a front perspective view of a platform of the boom lift of FIG. 1;

FIG. 5 is a front perspective view of a telehandler, according to an exemplary embodiment;

FIG. 6 is a side interior view of a cabin of the telehandler of FIG. 5;

FIG. 7 is a block diagram of a control system of the boom lift of FIG. 1;

FIG. 8A is a depiction of an image captured by a camera of the control system of FIG. 7;

FIG. 8B is another depiction of an image captured by a camera of the control system of FIG. 7;

FIG. 8C is another depiction of an image captured by a camera of the control system of FIG. 7;

FIG. 9 is a flow chart of a process for controlling a device based on image data captured by a camera, according to an exemplary embodiment;

FIG. 10 is a flow chart of a process for controlling user-operated industrial equipment based on image data captured by a camera, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a lift device includes a platform configured to support a user, a chassis, and a lift assembly coupling the platform to the chassis. The user may control the lift assembly to raise, lower, or otherwise move the platform through a user interface coupled to the platform. In some situations, it may be possible for an obstacle in the environment to push the user toward the user interface while the lift assembly moves the platform. To limit or prevent this, the platform includes a camera with a field of view (FOV) of the user interface and a portion of the platform railing. The camera may be positioned on the railing adjacent the user interface. The camera transmits image data indicative of the FOV to a controller. The controller utilizes the image data to assess whether a portion of the user's body, such as the torso/upper body of a user extends into an area of the FOV of the camera. The area may be predetermined. In response to determining that the portion of the body of the user extends into the area of the FOV, the controller stops or reverses movement of the lift device.

Additionally or alternatively, the camera may collect image data indicative of an operator status/condition. The controller utilizes the image data to determine whether one or more operator conditions are met for equipment operation. In response to at least one of the one or more operator conditions not being met, the controller may inhibit operation of the equipment (e.g., the lift device, a telehandler, etc.). Additionally or alternatively, the controller may transmit a notification to the user interface regarding the operator condition(s) that are not met.

### Lift Device

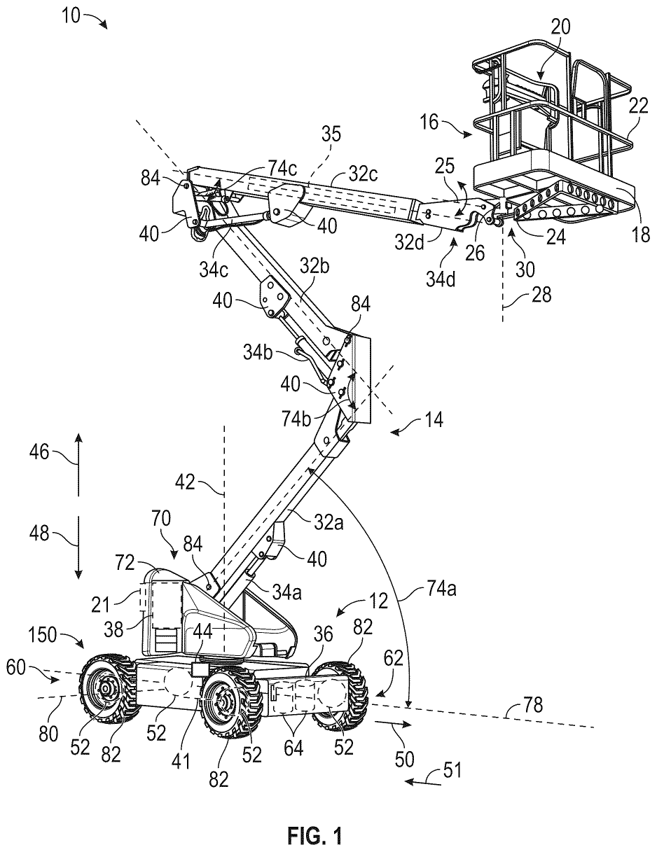

Referring to FIG. 1, a lifting apparatus, lift device, or mobile elevating work platform (MEWP) (e.g., a telehandler, an electric boom lift, a towable boom lift, a lift device, a fully electric boom lift, etc.), shown as lift device 10 includes a base assembly 12 (e.g., a base, a support assembly, a drivable support assembly, a support structure, a chassis, etc.), a the platform assembly 16 (e.g., a platform, a terrace, etc.), and a lift assembly 14 (e.g., a boom, a boom lift assembly, a lifting apparatus, an articulated arm, a scissors lift, etc.). The lift device 10 includes a front end (e.g., a forward-facing end, a front portion, a front, etc.), shown as front 62, and a rear end (e.g., a rearward facing end, a back portion, a back, a rear, etc. ,) shown as rear 60. The lift assembly 14 is configured to elevate the platform assembly 16 in an upwards direction 46 (e.g., an upward vertical direction) relative to the base assembly 12. The lift assembly 14 is also configured to translate the platform assembly 16 in a downwards direction 48 (e.g., a downward vertical direction). The lift assembly 14 is also configured to translate the platform assembly 16 in either a forward direction 50 (e.g., a forward longitudinal direction) or a rearward direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of lift device 10 and the rearward direction 51. The lift device 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the lift device 10. The tractive elements 82 can each include an electric motor 52 (e.g., electric wheel motors) configured to drive the tractive elements 82 (e.g., to rotate tractive elements 82 to facilitation motion of the lift device 10). In other embodiments, the tractive elements 82 are configured to receive power (e.g., rotational mechanical energy) from electric motors 52 or through a drive train (e.g., a combination of any number and configuration of a shaft, an axle, a gear reduction, a gear train, a transmission, etc.). In some embodiments, one or more tractive elements 82 are driven by a prime mover 41 (e.g., electric motor, internal combustion engine, etc.) through a transmission. In some embodiments, a hydraulic system (e.g., one or more pumps, hydraulic motors, conduits, valves, etc.) transfer power (e.g., mechanical energy) from one or more electric motors 52 and/or the prime mover 41 to the tractive elements 82. The tractive elements 82 and electric motors 52 (or prime mover 41) can facilitate a driving and/or steering function of the lift device 10.

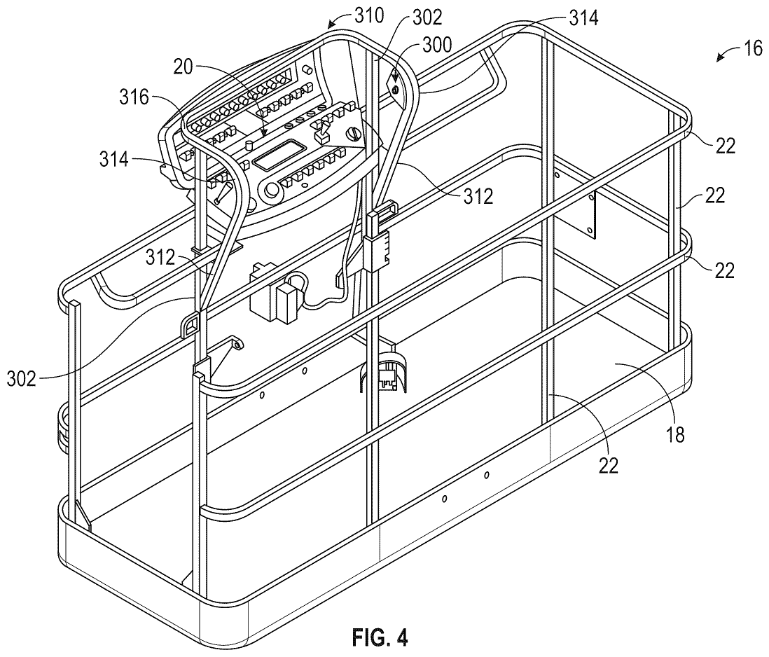

With additional reference to FIG. 4, the platform assembly 16 is shown in further detail. The platform assembly 16 is configured to provide a work area for an operator of the lift device 10 to stand/rest upon. The platform assembly 16 can be pivotally coupled to an upper end of the lift assembly 14. The lift device 10 is configured to facilitate the operator accessing various elevated areas (e.g., lights, platforms, the sides of buildings, building scaffolding, trees, power lines, etc.). The lift device 10 may use various electrically powered motors and electrically powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon).

The platform assembly 16 includes a base member, a base portion, a platform, a standing surface, a shelf, a work platform, a floor, a deck, etc., shown as a deck 18. The deck 18 provides a space (e.g., a floor surface) for a worker to stand upon as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the lift device 10 to grasp while using the lift device 10 (e.g., to grasp while operating the lift device 10 to elevate the platform assembly 16). The rails 22 can include members that are substantially horizontal to the deck 18. The rails 22 can also include vertical structural members that couple with the substantially horizontal members. The vertical structural members can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the lift device 10. The user interface 20 can include any number of buttons, levers, switches, keys, etc., or any other user input device configured to receive a user input to operate the lift device 10. The user interface 20 may also provide information to the user (e.g., through one or more displays, lights, speakers, haptic feedback devices, etc.). The user interface 20 can be supported by one or more of the rails 22.

Referring to FIG. 1, the platform assembly 16 includes a frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotally coupled with the lift assembly 14 to facilitate rotation of the platform assembly 16 about an axis 28 (e.g., a vertical axis as shown in FIG. 1). The frame 24 can also rotatably/pivotally couple with the lift assembly 14 such that the frame 24 and the platform assembly 16 can pivot about an axis 25 (e.g., a horizontal axis as shown in FIG. 1).

The lift assembly 14 includes one or more beams, articulated arms, bars, booms, arms, support members, boom sections, cantilever beams, etc., shown as lift arms 32a, 32b, and 32c. The lift arms are hingedly or rotatably coupled with each other at their ends. The lift arms can be hingedly or rotatably coupled to facilitate articulation of the lift assembly 14 and raising/lowering and/or horizontal movement of the platform assembly 16. The lift device 10 includes a lower lift arm 32a, a central or medial lift arm 32b, and an upper lift arm 32c. The lower lift arm 32a is configured to hingedly or rotatably couple at one end with the base assembly 12 to facilitate lifting (e.g., elevation) of the platform assembly 16. The lower lift arm 32a is configured to hingedly or rotatably couple at an opposite end with the medial lift arm 32b. Likewise, the medial lift arm 32b is configured to hingedly or rotatably couple with the upper lift arm 32c. The upper lift arm 32c can be configured to hingedly interface/couple and/or telescope with an intermediate lift arm 32d. The upper lift arm 32c can be referred to as “the jib” of the lift device 10. The intermediate lift arm 32d may extend into an inner volume of the upper lift arm 32c and extend and/or retract. The lower lift arm 32a and the medial lift arm 32b may be referred to as “the boom” of the overall lift device 10 assembly. The intermediate lift arm 32d can be configured to couple (e.g., rotatably, hingedly, etc.), with the platform assembly 16 to facilitate levelling of the platform assembly 16.

The lift arms 32 are driven to hinge or rotate relative to each other by actuators 34a, 34b, 34c, 34d (e.g., electric linear actuators, linear electric arm actuators, hydraulic cylinders, etc.). The actuators 34a, 34b, 34c, 34d can be mounted between adjacent lift arms to drive adjacent lift arms to hinge or pivot (e.g., rotate some angular amount) relative to each other about pivot points 84. The actuators 34a, 34b, 34c, 34d can be mounted between adjacent lift arms using any of a foot bracket, a flange bracket, a clevis bracket, a trunnion bracket, etc. The actuators 34a, 34b, 34c, 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle 74a defined between a centerline of the lower lift arm 32a and the longitudinal axis 78 (angle 74a can also be defined between the centerline of the lower lift arm 32a and a plane defined by the longitudinal axis 78 and lateral axis 80) and facilitate lifting of the platform assembly 16 (e.g., moving the platform assembly 16 at least partially along the upward direction 46). Likewise, the actuator 34b can be configured to retract to decrease the angle 74a to facilitate lowering of the platform assembly 16 (e.g., moving the platform assembly 16 at least partially along the downward direction 48). Similarly, the actuator 34b is configured to extend to increase the angle 74b defined between centerlines of the lower lift arm 32a and the medial lift arm 32b and facilitate elevating of the platform assembly 16. Similarly, the actuator 34b is configured to retract to decrease the angle 74b to facilitate lowering of the platform assembly 16. The electric actuator 34c is similarly configured to extend/retract to increase/decrease the angle 74c, respectively, to raise/lower the platform assembly 16.

The actuators 34a, 34b, 34c, 34d can be mounted (e.g., rotatably coupled, pivotally coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The intermediate lift arm 32d and the frame 24 are configured to pivotally interface/couple at a platform rotator 30 (e.g., a rotary actuator, a rotational electric actuator, a gear box, etc.). The platform rotator 30 facilitates rotation of the platform assembly 16 about the axis 28 relative to the intermediate lift arm 32d. In some embodiments, the platform rotator 30 is positioned between the frame 24 and the upper lift arm 32c and facilitates pivoting of the platform assembly 16 relative to the upper lift arm 32c. The axis 28 extends through a central pivot point of the platform rotator 30. The intermediate lift arm 32d can also be configured to articulate or bend such that a distal portion of the intermediate lift arm 32d pivots/rotates about the axis 25. The intermediate lift arm 32d can be driven to rotate/pivot about axis 25 by extension and retraction of the actuator 34d.

The intermediate lift arm 32d is also configured to extend/retract (e.g., telescope) along the upper lift arm 32c. In some embodiments, the lift assembly 14 includes a linear actuator (e.g., a hydraulic cylinder, an electric linear actuator, etc.), shown as extension actuator 35, that controls extension and retraction of the intermediate lift arm 32d relative to the upper lift arm 32c. In other embodiments, one or more of the other arms of the lift assembly 14 include multiple telescoping sections that are configured to extend/retract relative to one another.

The platform assembly 16 is configured to be driven to pivot about the axis 28 (e.g., rotate about axis 28 in either a clockwise or a counter-clockwise direction) by an electric or hydraulic motor 26 (e.g., a rotary electric actuator, a stepper motor, a platform rotator, a platform electric motor, an electric platform rotator motor, etc.). The motor 26 can be configured to drive the frame 24 to pivot about the axis 28 relative to the upper lift arm 32c (or relative to the intermediate lift arm 32d). The motor 26 can be configured to drive a gear train to pivot the platform assembly 16 about the axis 28.

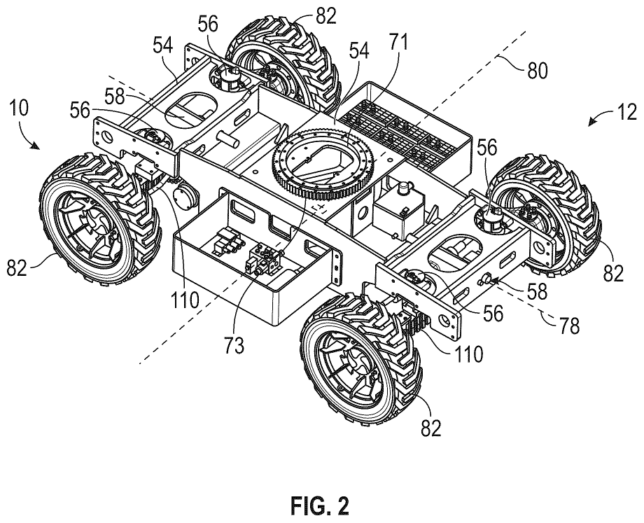

Referring to FIGS. 1 and 2, the lift assembly 14 is configured to pivotally or rotatably couple with the base assembly 12. The base assembly 12 includes a rotatable base member, a rotatable platform member, a fully electric turntable, etc., shown as a turntable 70. The lift assembly 14 is configured to rotatably/pivotally couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slew bearing 71 (e.g., the slew bearing 71 pivotally couples the turntable 70 to the base 36). The turntable 70 facilitates accessing various elevated and angularly offset locations at the platform assembly 16. The turntable 70 is configured to be driven to rotate or pivot relative to base 36 and about the slew bearing 71 by an electric motor, an electric turntable motor, an electric rotary actuator, a hydraulic motor, etc., shown as the turntable motor 44. The turntable motor 44 can be configured to drive a geared outer surface 73 of the slew bearing 71 that is rotatably coupled to the base 36 about the slew bearing 71 to rotate the turntable 70 relative to the base 36. The lower lift arm 32a is pivotally coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64. The batteries 64 are configured to store energy in a form (e.g., in the form of chemical energy) that can be converted into electrical energy for the various electric motors and actuators of the lift device 10. The batteries 64 can be stored within the base 36. The lift device 10 includes a controller 38 that is configured to operate any of the motors, actuators, etc., of the lift device 10. The controller 38 can be configured to receive sensory input information from various sensors of the lift device 10, user inputs from the user interface 20 (or any other user input device such as a key-start or a push-button start), etc. The controller 38 can be configured to generate control signals for the various motors, actuators, etc., of the lift device 10 to operate any of the motors, actuators, electrically powered movers, etc., of the lift device 10. The batteries 64 are configured to power any of the motors, sensors, actuators, electric linear actuators, electrical devices, electrical movers, stepper motors, etc., of the lift device 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The batteries 64 are configured to deliver power to the motors 52 to drive the tractive elements 82. A rear set of tractive elements 82 can be configured to pivot to steer the lift device 10. In other embodiments, a front set of tractive elements 82 are configured to pivot to steer the lift device 10. In still other embodiments, both the front and the rear set of tractive elements 82 are configured to pivot (e.g., independently) to steer the lift device 10. In some examples, the base assembly 12 includes a steering system 150. The steering system 150 is configured to drive tractive elements 82 to pivot for a turn of the lift device 10. The steering system 150 can be configured to pivot the tractive elements 82 in pairs (e.g., to pivot a front pair of tractive elements 82) or can be configured to pivot tractive elements 82 independently (e.g., four-wheel steering for tight-turns).

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.)

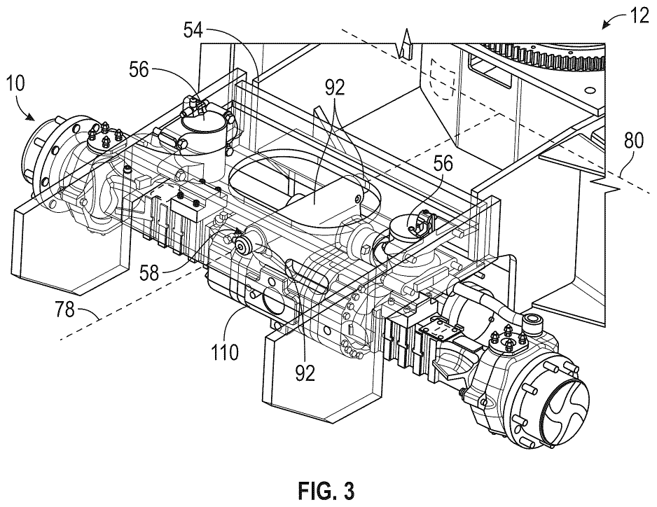

Referring now to FIGS. 2 and 3, the base assembly 12 includes a longitudinally extending frame member 54 (e.g., a rigid member, a structural support member, an axle, a base, a frame, a carriage, a chassis, etc.). The longitudinally extending frame member 54 provides structural support for the turntable 70 as well as the tractive elements 82. The longitudinally extending frame member 54 is pivotally coupled with lateral frame members 110 (e.g., axles, frame members, beams, bars, etc.) at opposite longitudinal ends of the longitudinally extending frame member 54. For example, the lateral frame members 110 may be pivotally coupled with the longitudinally extending frame member 54 at a front end and a rear end of the longitudinally extending frame member 54. The lateral frame members 110 can each be configured to pivot about a pivot joint 58 (e.g., about a longitudinal axis). The pivot joint 58 can include a pin and a receiving portion (e.g., a bore, an aperture, etc.). The pin of the pivot joint 58 is coupled to one of the lateral frame members 110 (e.g., a front lateral frame member 110 or a rear lateral frame member 110) or the longitudinally extending frame member 54 and the receiving portion is coupled to the other of the longitudinally extending frame member 54 and the lateral frame member 110. For example, the pin may be coupled with longitudinally extending frame member 54 and the receiving portion can be coupled with one of the lateral frame members 110 (e.g., integrally formed with the front lateral frame member 110).

In some embodiments, the longitudinally extending frame member 54 and the lateral frame members 110 are integrally formed or coupled (e.g., fastened, welded, riveted, etc.) to define the base 36. In still other embodiments, the base 36 is integrally formed with the longitudinally extending frame member 54 and/or the lateral frame members 110. In still other embodiments, the base 36 is coupled with the longitudinally extending frame member 54 and/or the lateral frame members 110.

The base assembly 12 includes one or more axle actuators 56 (e.g., electric linear actuators, electric axle actuators, electric levelling actuators, hydraulic cylinders, etc.). The axle actuators 56 can be linear actuators configured to receive power from the batteries 64, for example. The axle actuators 56 can be configured to extend or retract to contact a top surface of a corresponding one of the lateral frame members 110. When the axle actuators 56 extend, an end of a rod of the levelling actuators can contact the surface of lateral frame member 110 and prevent relative rotation between lateral frame member 110 and longitudinally extending frame member 54. In this way, the relative rotation/pivoting between the lateral frame member 110 and the longitudinally extending frame member 54 can be locked (e.g., to prevent rolling of the longitudinally extending frame member 54 relative to the lateral frame members 110 during operation of the lift assembly 14). The axle actuators 56 can receive power from the batteries 64, which can allow the axle actuators 56 to extend or retract. The axle actuators 56 can receive control signals from the controller 38.

Referring to FIG. 4, a front perspective view of a platform assembly 16 of the lift device 10 is shown, according to example embodiments. Specifically, the rails 22 include a pair of frame members, shown as vertical rails 302, that extend vertically upward from the deck 18. The vertical rails 302 are positioned on opposite sides of the user interface 20 such that the user interface 20 extends laterally between the vertical rails 302. A rail, shown as cage 310, is fixedly coupled to the vertical rails 302 and extends around the user interface 20. Specifically, the cage 310 extends laterally between the vertical rails 302, longitudinally forward of the vertical rails 302, and longitudinally rearward of the vertical rails 302. In some embodiments, the cage 310 extends either longitudinally forward or longitudinally rearward of the vertical rails 302. The cage 310 includes a pair of inclined portions 312, each extending at angle (i.e., longitudinally forward) and vertically upward from a middle portion of one of the vertical rails 302. The cage 310 further includes a pair of curved portions 314, each coupled to an upper end of one of the inclined portions 312. The curved portions 314 each extend upward and longitudinally rearward from the corresponding inclined portion 312. A u-shaped horizontal portion 316 is coupled to both of the curved portions 314. The horizontal portion 316 extends longitudinally rearward from the curved portions 314 and laterally between the curved portions 314. The horizontal portion 316 is coupled to the top end of each vertical rail 302. The curved portions 314 and the horizontal portion 316 both extend above the user interface 20. In some embodiments, one or more additional horizontal portions are included between the inclined portions 312.

In some embodiments, one or more cameras, shown as camera 300, are coupled to the rails 22 and/or the user interface 20. The camera 300 is mounted (e.g., coupled, welded, attached, supported by, etc.) in a location that, depending on the field of view of the camera 300, allows the camera 300 to collect image data for the control system 200 to perform the systems and methods described herein. As shown in FIG. 4, the camera 300 is coupled to a curved portion 314 of the cage 310, such that the user interface 20 and the opposite curved portion 314 of the cage 310 are within the FOV of the camera 300. In this way, the camera 300 is positioned to capture interruptions in the FOV by a portion of an operator of the lift device 10. Specifically, the camera 300 is positioned to capture image data indicative of an operator (OP) of the lift device 10 falling towards or being pushed into the user interface 20 (e.g., by an obstacle, etc.). In some embodiments, the camera 300 may be mounted or arranged in various other locations near the user interface. For example, in some instances, the camera 300 may be mounted on the horizontal portion 316 or another location above the user interface 20 facing rearward (e.g. to capture images of the operator from a front perspective).

While depicted herein as a camera 300, the camera 300 can include, or in fact be, other sensors. For example, the camera 300 can be or include any one and/or a combination of camera(s), proximity sensor(s), infrared sensor(s), electromagnetic sensor(s), capacitive sensor(s), photoelectric sensor(s), inductive sensor(s), radar sensor(s), ultrasonic sensor(s), Hall Effect sensor(s), fiber optic sensor(s), Doppler Effect sensor(s), magnetic sensor(s), laser sensor(s) (e.g., LIDAR sensors), sonar sensor(s), and/or the like. In some embodiments, the camera 300 includes an image capture device such as visible light cameras, full-spectrum cameras, image sensors (e.g., charged-coupled device (CCD), complementary metal oxide semiconductor (CMOS) sensors, etc.), or any other type of suitable object sensor or imaging device. Accordingly, any reference herein to the camera 300 may also apply to these other types of sensors.

Sensor data captured by the camera 300 may include, for example, raw image data from one or more cameras (e.g., visible light cameras) and/or proximity data from one or more sensors (e.g., LIDAR, radar, etc.) that may be used to detect objects. In other embodiments, sensor data captured by the camera 300 is video feed data obtained from the camera 300 regarding one or more areas in and/or surrounding platform assembly 16. For example, the sensor data may be or include video feed data (e.g., live or real-time video feed data) of the front, sides, rear, and/or interior of the platform assembly 16. In some embodiments, multiple cameras 300 may be used in order to provide multiple feeds of image data to the controller 38, which may be configured to compile (e.g., cross-reference based on known relative locations of the multiple cameras 300) the image data.

In some embodiments, the camera 300 is active during operation of the platform assembly 16. Additionally or alternatively, the camera 300 may become active in response to a detected operation mode of the platform assembly 16. For example, the camera 300 may activate in response to another sensor (e.g., another camera 300, a low-power camera, a motion detector, etc.) detecting the presence of an operator aboard the platform assembly 16.

### Telehandler

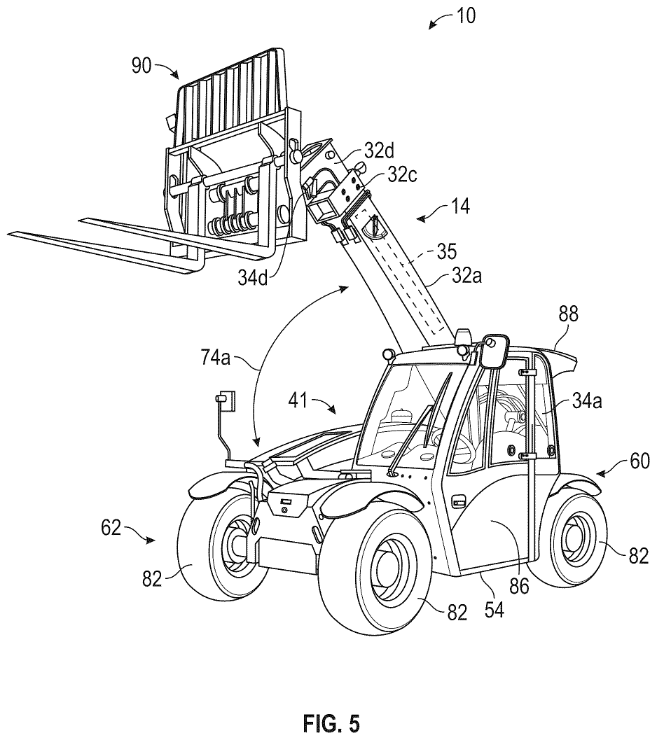

Referring to FIG. 5, a lift device 10 is shown as a telehandler according to an exemplary embodiment. In other embodiments, the lift device 10 is another type of lift device, such as a boom lift, an aerial work platform, a scissor lift, a vertical lift, a compact crawler boom, a forklift, a crane, a bucket truck, or another type of lift device. In yet other embodiments, the lift device 10 is another type of vehicle or work machine, such as a military vehicle, a cement truck, a refuse vehicle, a fire apparatus (e.g., a fire truck including a deployable ladder, an aircraft rescue and firefighting truck, etc.), a tow truck, or another type of vehicle or work machine.

As shown in FIG. 5, the lift device 10 includes a chassis, shown as frame member 54, having a front end 62 and a rear end 60. The frame member 54 supports an enclosure, shown as cabin 88, which is configured to house an operator of the lift device 10. The enclosure is shown to include a door 86 configured to enclose an operator within the cabin 88. The lift device 10 is supported by a plurality of tractive elements 82 that are rotatably coupled to the frame member 54. As shown, the tractive elements 82 include a pair of front wheels (e.g., supported on a front axle) positioned proximate the front end 62 and a pair of rear wheels (e.g., supported on a rear axle) positioned proximate the rear end 60. One or more of the tractive elements 82 may be powered (e.g., driven by an engine, driven by an electric motor, etc.) to facilitate motion of the lift device 10. Each of the tractive elements 82 may be powered or unpowered. In example embodiments, the lift device 10 includes a powertrain system including a primary driver, shown as prime mover 41.

The lift device 10 includes a lift assembly 14 having a proximal end that is pivotably coupled to the frame member 54 near the rear end 60. The lift assembly 14 is shown to include a lower lift arm 32a, an upper lift arm 32c, and an intermediate lift arm 32d. A distal end of the lift assembly 14 supports a tool or manipulator, shown as implement 90. The implement 90 may be any type of mechanism used to support, grab, or otherwise interact with the payload. The implement 90 may include one or more of a carriage and/or set of forks (e.g., pallet forks, bale forks, etc.), a bucket, a grapple or grab (e.g., a bale grab, a log grab, a shear grab, a grab for use in combination with a bucket, etc.), a boom (e.g., a boom supporting a cable used to manipulate roof trusses), an auger, a concrete bucket, a platform (e.g., platform assembly 16), or another type of implement.

The lift device 10 may permit an operator to control the tractive elements 82 and the lift assembly 14 from within the cabin 88 to manipulate (e.g., move, carry, lift, transfer, etc.) a payload (e.g., pallets, building materials, earth, grain, etc.). The upper lift arm 32c can include a series of boom sections that translate relative to one another to vary an overall length of the lift assembly 14. The lower lift arm 32a is pivotally coupled to the frame member 54 and pivotable relative to the frame member 54 about a lateral axis (e.g., a ground surface). The upper lift arm 32c may include one or more telescoping components that are received within the lower lift arm 32a and slidable relative to the lower lift arm 32a. The intermediate lift arm 32d is received within most distal of the upper lift arm 32c and slidable relative to the upper lift arm 32c.

The lift assembly 14 and the implement 90 are articulated by a series of actuators 34a, 34d, 35. The actuators are configured to control the lift assembly 14 to lift or otherwise manipulate various loads. The actuators 34a, 34d, 35 may be hydraulic cylinders powered by pressurized fluid from a pump that extend and retract linearly. In such embodiments, the hydraulic cylinders each include a body that defines an interior volume and receives a shaft. A piston is connected to the shaft and engages an interior surface of the body, dividing the interior volume of the body into a pair of chambers. Pressurized hydraulic fluid is selectively pumped (e.g., by a pump) into each of the chambers to selectively expand or contract the hydraulic cylinder. The hydraulic cylinders may include bosses, clevises, or other features to facilitate interfacing with other components (e.g., the frame member 54, the boom sections, etc.). In other embodiments, the actuators 34a, 34d, 35 are another type of linear actuator (e.g., electrical, pneumatic, etc.) or are rotary actuators.

A lift actuator, shown as actuator 34a is configured to raise and/or lower the lift assembly 14 by rotating the lower lift arm 32a along the angle 74a. An extension actuator 35 is coupled to the lower lift arm 32a and one of the other boom sections (e.g., the upper lift arm 32c, a medial lift arm 32b, etc.). The extension actuator 35 is configured to vary the length of the lift assembly 14 by causing the upper lift arm 32c to translate relative to the lower lift arm 32a. The actuator 34d is coupled to the implement 90 and the intermediate lift arm 32d. The actuator 34d is configured to reposition (e.g., pivot) the implement 90 relative to the upper lift arm 32c.

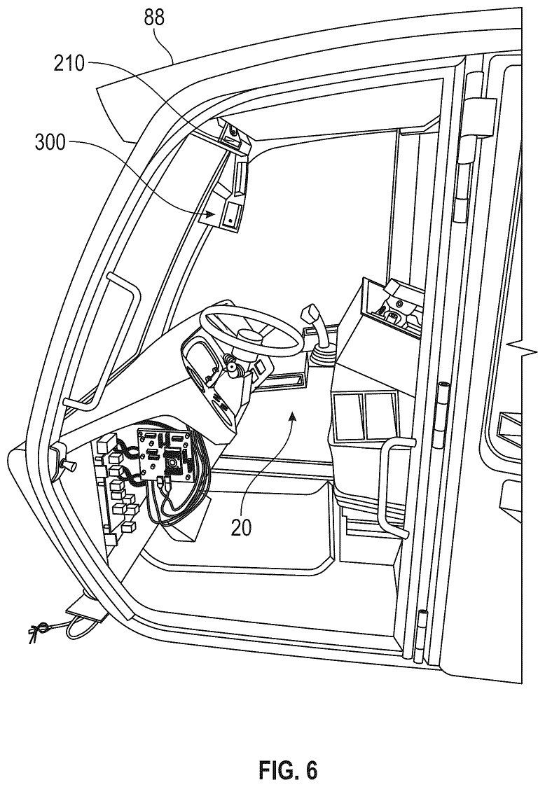

Referring to FIG. 6, the interior of the cabin 88 is shown, according to an example embodiment. The interior of the cabin 88 is shown to include a user interface 20. As discussed with regards to FIG. 3 above, the user interface 20, may include screens, buttons, switches, joysticks, steering wheels, or other conventional types of interface devices. The user interface 20 may be disposed within the cabin 88. Additionally or alternatively, the user interface 20 may be included as part of a user device (e.g., a smartphone, a table, a laptop computer, a desktop computer, etc.) or as part of the implement 90. The user interface 20 is configured to receive user inputs from the operator to facilitate operation of the lift device 10. For example, the controller 38 can be configured to generate control signals for the various motors, actuators, etc., of the lift device 10 to operate any of the motors 26, 52 (not shown), actuators 34a, 34c, 34d, electrically powered movers, etc., of the lift device 10. The user interface 20 or the cabin 88 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The interior of the cabin 88 is shown to include a camera 300 configured to collect image data indicative of a status of an operator of the lift device 10. As shown in FIG. 6, the camera 300 is coupled to an upper portion of a windshield of the lift device 10. In some embodiments, additional cameras 300 are disposed in or around the cabin 88, such that the cameras 300 capture image data associated with each operator within the cabin 88 of the lift device 10. In some embodiments, the camera 300 is a 360° FOV camera positioned on a ceiling of the cabin 88, to simultaneously capture the left, right, front, and/or back of an operator in the cabin 88.

### Control System

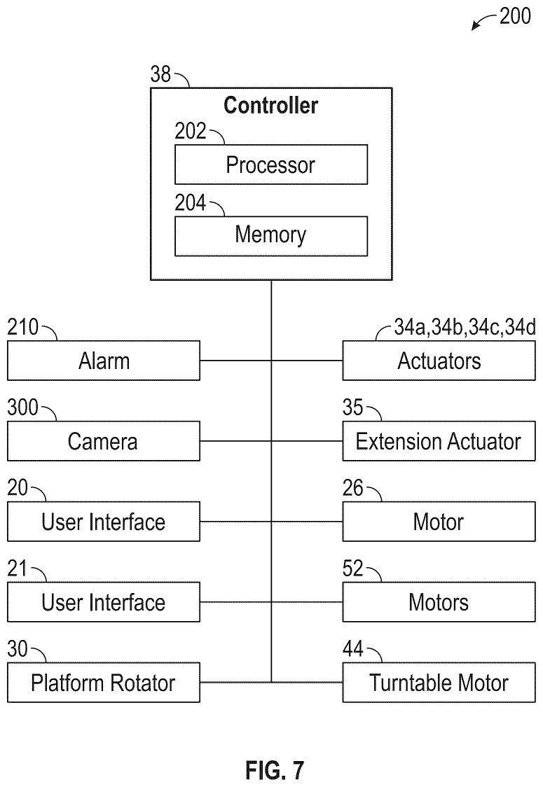

Referring to FIG. 7, a block diagram of a control system 200 is shown, according to an example embodiment. In this example, the control system 200 is shown to be included in the lift device 10. The control system 200 includes the controller 38. The controller 38 includes a processor 202 and a memory device, shown as memory 204. The memory 204 may contain one or more programs or instructions for execution by the processor 202.

As shown in FIG. 7, the controller 38 is operatively coupled to (e.g., in communication with) the motor 26, the platform rotator 30, the turntable motor 44, the actuators (e.g., the actuator 34a, 34b, 34c, 34d, 35, etc.), the extension actuator 35, and the motors 52. The controller 38 is operatively coupled to one or both of the user interface 20 and the user interface 21. The controller 38 is operatively coupled to an indicator, shown as alarm 210. The alarm 210 may provide an indication, alert, or warning to a user when activated. The indication from the alarm 210 may be visual, auditory, or another type of indication (e.g., vibrational haptic feedback). By way of example, the alarm 210 may provide an auditory indication (e.g., a siren) or a visual indication (e.g., a flashing light) to a user. For example, and as shown in FIG. 6, the alarm may be a light display that shows a light of a predetermined color corresponding to a status of an operator (e.g., green indicating a seatbelt is on an operator, red indicating a seatbelt is not on an operator, etc.). The controller 38 is operatively coupled to one or more optical sensors, shown as camera 300. As described herein, the camera 300 is configured to transmit visual data to the controller 38 indicative of an interruption in the FOV of the camera 300 and/or a status of an operator condition. The camera 300 may be positioned such that a user positioned within the FOV of the camera 300. For example, the camera 300 may be positioned such that an operator is regularly positioned (e.g., centered, offset to a side, out of frame, etc.) within a predefined percentage of the FOV of the camera 300 when interacting with user interface 20 or 21. When a portion of an operator's body (e.g., a torso, a stomach, a shoulder, etc.) moves toward and/or within the FOV of the camera 300, the controller 38 may automatically operate one or more components of the lift device 10 (e.g., actuators 34a, 34b, 34c, extension actuator 35, motor 26, 52, turntable motor 44, etc.) based on the portion of the operator detected by the camera 300. Although FIG. 7 only illustrates operative coupling between the controller 38 and certain components of the lift device 10, it should be understood that other components may be in communication with the controller 38 as well. By way of example, the batteries 64 may be operatively coupled to the controller 38.

The controller 38 may be configured to receive information (e.g., user instructions, sensor signals, etc.) from one or more components of the lift device 10. By way of example, the controller 38 may receive user inputs or commands from the user interface 20 and/or the user interface 21. By way of another example, the controller 38 may receive an input from the camera 300 (e.g., a signal indicating that a user is near an obstacle, a signal indicating a user condition).

The controller 38 may be configured to provide information (e.g., commands, indication, etc.) to one or more components of the lift device 10. By way of example, the controller 38 may send commands (e.g., signals) that control the outputs (e.g., movement) of the motor 26, the actuators 34, the extension actuator 35, the motors 52, and/or any other actuators of the lift device 10. By way of another example, the controller 38 may provide a command to the alarm 210 that causes the alarm 210 to activate. By way of another example, the controller 38 may provide commands that cause the user interface 20 and/or the user interface 21 to provide (e.g., display) information to a user.

### Image-based Recognition of Operator Status

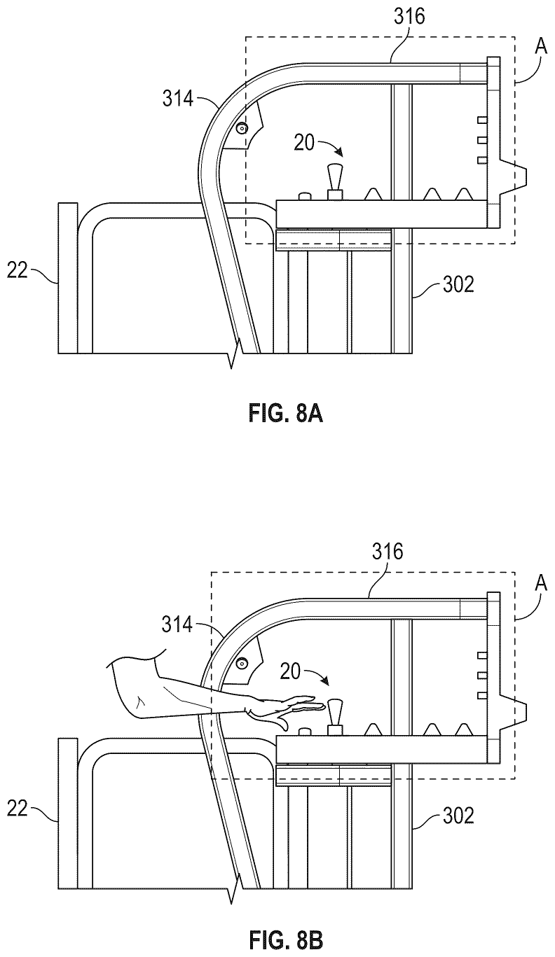

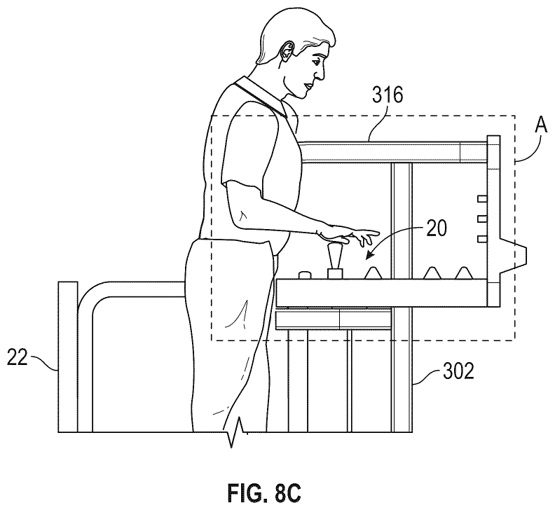

Referring to FIG. 8A-8C, the FOV of the camera 300 of FIG. 4 is shown, according to an embodiment. As shown in FIG. 8A, the camera 300 is mounted such that the camera 300 captures the user interface 20 and a portion of the cage 310 railing, and more specifically, the curved portions 314 of the cage 310 railing are captured within the FOV of the camera 300. The FOV of the camera 300 may capture all or a portion of an operator. The camera 300 transmits image data indicative of the camera's FOV to the controller 38.

As the user operates the lift device 10, they generally stand in front of the user interface 20 and face toward the user interface 20. The expected area the user may stand in may be mapped to a position in the FOV of the camera 300, such that a predetermined area of the FOV may align with the expected area the user would stand in. In some situations, the lift assembly 14, the turntable 70, and/or the motors 52 move the platform assembly 16 in proximity to an obstacle (e.g., a tree, a portion of a structure such as a support beam, etc.). In some such situations, the user is positioned between the user interface 20 and the obstacle. As the lift assembly 14 moves the platform assembly 16, the distance between the user interface 20 and the obstacle may decrease, limiting the freedom of movement of the operator. In some such cases, it may be difficult for the user to access the controls of the user interface 20 to move the platform assembly 16 away from the obstacle, and the operator may be in danger of being pushed into the platform 16, the user interface 20, and/or the obstacle.

The controller 38 receives image data indicative of the FOV of the camera 300 from the camera 300. The processor 202 may receive the image data and perform object detection (e.g., detecting an object-of-interest). As shown in FIG. 8A-8C, the controller 38 imposes an area A over a portion of the image data. The area A is associated with a “danger zone” for the operator. For example, the predetermined area A is positioned over the portion of the image data associated with the front railing of the cage 310 and the user interface 20. In some embodiments, the area A is predetermined. The predetermined area A can be any known area wherein an operator may be at an increased risk for being hit by an obstacle or for being trapped between the obstacle and one or more components of the lift device 10. For another example, the predetermined area A may be the area between a railing 22 of the platform 16 and the obstacle. In some embodiments, the area A is actively maintained, such that it may change its size, shape, or position based on one or more signals provided to the controller 38. For example, each time an obstacle is detected, the controller 38 may impose an area A over the image data between the obstacle and the lift device 10. In some embodiments, for example, the area A may change depending on the movement of the platform 16. In example embodiments, the processor 202 performs object detection on the area A to determine whether an operator is positioned within the area of the platform assembly 16 associated with the area A and/or to determine if an obstacle is present. Based on the object detection performed on the predetermined area A, the controller 38 may operate one or more components of the lift device 10 to move or stop the lift device 10.

For example, as shown in FIG. 8B, the processor 202 may perform object detection to determine that a hand of the operator is within the area A. Responsive to determining that a hand, forearm, or arm of the operator is within the area A, the controller 38 permits standard control of the lift device 10.

In the example shown in FIG. 8C, the processor 202 may determine that a torso of the operator is within the area A. The torso of the operator being within the area A indicates that the operator may be in a dangerous position, where if trapped in that position by an obstacle, the operator may be unable to operate the controls of the user interface 20. For example, the operator is at risk of being pushed into or falling forward onto the user interface 20 (e.g., due to impact with an obstacle during operation of the lift device 10). Responsive to determining that the torso of the operator is within the area A, the controller 38 may be configured to perform one or more actions to stop or reverse one or more recent movements of the lift device 10. The actions may free an operator or allow the operator to access the user interface 20 and free themselves. The controller 38 may additionally or alternatively activate the alarm 210 in response to receiving the second signal. By way of example, the controller 38 may stop movement of all of the actuators of the lift device 10 (e.g., the actuators 34, the motors 26, 52, etc.). By taking this action, the controller 38 may ensure that the platform assembly 16 does not move further relative to the obstacle.

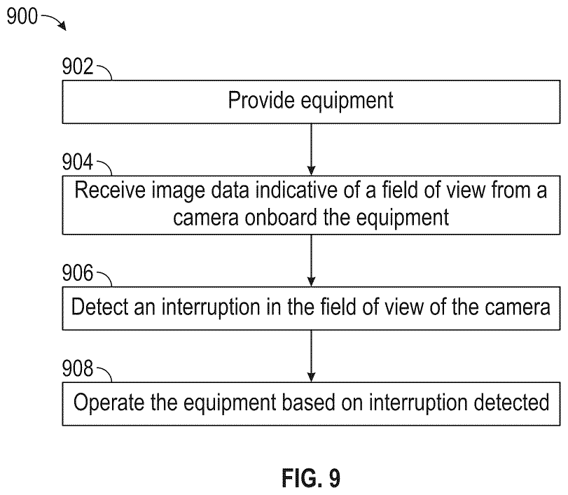

Referring to FIG. 9, a flow chart of a process 900 for controlling a device (e.g., the lift device 10) based on image data captured by a camera (e.g., the camera 300) is shown, according to an embodiment. A controller (e.g., the controller 38) associated with the device performs the process 900, according to example embodiments.

At step 902, user-operated equipment having a controller thereon is provided to a user/operator. The equipment may be, for example, the lift device 10, a vehicle or work machine, such as a military vehicle, a cement truck, a refuse vehicle, a fire apparatus (e.g., a fire truck including a deployable ladder, an aircraft rescue and firefighting truck, etc.), a tow truck, or another type of vehicle or work machine. The equipment is outfitted with one or more cameras (e.g., cameras 300) having an FOV of an operator workspace on the equipment (e.g., the platform assembly 16, the cabin 88, etc.).

At step 904, the controller receives image data indicative of the FOV of the camera(s) onboard the equipment. In example embodiments, the camera captures image data associated with a particular portion of the equipment. For example, the camera captures image data associated with the user interface 20 and the front railing of the platform assembly 16 of the lift device 10. As discussed with regards to FIG. 8A-8C, the controller may impose an area (e.g., area A) over a portion of the image data transmitted by the camera. As discussed above, the area A may indicate a “danger zone” for the associated area on the equipment (e.g., the front railings of the cage 310, the user interface 20, etc.).

At step 906, the controller detects an interruption in the FOV of the camera. In some examples, the controller performs image recognition on the image data transmitted from the camera to determine the position of an operator relative to the occupiable workspace on the equipment and/or what portion of the operator is in the FOV (e.g., the railings of the cage 310 and/or the user interface 20). For example, the controller may perform image recognition to differentiate between the operator's arms/hands and the operator's torso. In particular, the controller may detect when an arm, hand, or torso enters the area. In some examples, the controller determines a percentage of the area covered by the operator (e.g., percentage of pixels occupied by the operator in the image data, etc.). Additionally or alternatively, the controller may perform image detection to determine whether an obstacle is within the FOV of the camera.

At step 908, the controller operates one or more components of the equipment based on the interruption in the FOV of the camera detected at step 906. For example, if the controller detects a hand or arm within the area, the controller permits regular/normal operation of the equipment. Conversely, if the controller detects a torso within the area, the controller operates one or more components of the equipment to stop or move the equipment. For example, as described above, the torso of the operator being within the area indicates that the operator is being pushed or has fallen forward (e.g., due to impact with an obstacle during operation of the lift device 10). Responsive to determining that the torso of the operator is within the area, the controller may perform one or more actions to stop or reverse one or more recent movements of the equipment. In some examples, the controller (e.g., via the camera) may further detect various events outside of the workspace and/or the area A. For example, in some examples, the controller detects that the hand of the operator is positioned between the workspace and an obstacle (e.g., a tree, a pole, a wall), indicating a pinch risk. The controller may transmit a notification to a user interface, operate an alarm, and/or display a notification regarding the pinch risk. In some examples, the controller may perform an action, such as stopping or reversing the equipment, responsive to detecting a pinch risk.

As another example, the controller may compare the percentage of the area covered by the operator to a threshold portion (e.g., regardless of the portion of the operator's body detected). By way of example, the threshold portion may be in a range of 30%-60% of the area A (e.g., 30-60% of the total pixels contained in the area A), or more specifically, the threshold portion may be 40% of the area A. Responsive to the percentage of the area covered by the operator exceeding the threshold, the controller may perform one or more actions to stop or reverse one or more recent movements of the equipment.

In some examples, the controller may determine that an obstacle is within the FOV of the camera or within the area (e.g., area A) (e.g., a tree limb, a pole, a power line, etc.). Responsive to determining that an obstacle is within a specified area or proximity of the operator or the workspace, the controller may perform one or more actions to stop or reverse one or more recent movements of the equipment. For example, the controller may perform image recognition and determine that an obstacle is present within the area. Responsive to determining an obstacle is within the area, the controller may stop or reverse one or more recent movements of the equipment. Additionally or alternatively, the controller may transmit a reporting signal to a remote system (e.g., a fleet manager, etc.) regarding the detected interruption. For example, the controller may transmit a notification to a remote display device indicating that an operator has fallen or been impacted by an obstacle.

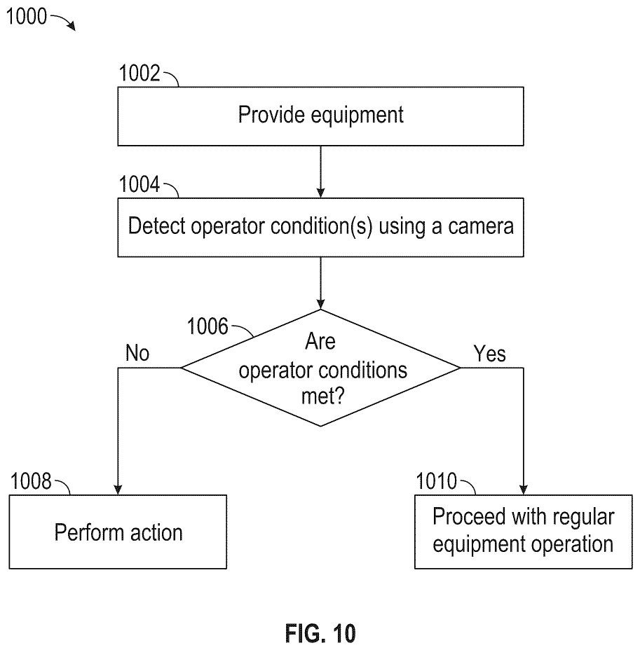

Referring to FIG. 10, a flow chart of a process 1000 for controlling user-operated industrial equipment (e.g., the lift device 10, etc.) based on image data captured by a camera (e.g., the camera 300) is shown, according to an embodiment. A controller (e.g., the controller 38) associated with the device performs the process 1000, according to example embodiments. Step 1002 may be the same or substantially similar to the step 902 described above.

At step 1004, the controller receives image data from one or more cameras. The controller performs image recognition to detect one or more operator conditions. In some examples, the detectable operator conditions are transmitted as a package to the controller by a remote system (e.g., the remote system provides instructions as to which operator conditions the controller is to monitor for). In other examples, operator conditions may be preset by a user via a user interface (e.g., the user interface 20). Prior to detecting operator conditions, the controller may receive data indicative of the number of operators onboard or in a predetermined vicinity of the equipment. The image data from the one or more cameras in addition or as an alternative to weight data from one or more weight sensors may be utilized by the controller to determine the number of operators onboard or in the predetermined vicinity of the equipment.

The camera alone, or in combination with weight sensors, other optical sensors, seat switches, or the like, may transmit data to the controller indicative of one or more operator conditions. As used in the following description, a “first operator condition” may be whether each operator is wearing a seatbelt; a “second operator condition” may be whether an operator is looking in the direction of travel; a “third operator condition” may be whether the operator(s) are wearing required personal protective equipment (PPE) (e.g., hard hats, safety glasses, harnesses, etc.); a “fourth operator condition” may be whether an operator is lifting objects correctly; a “fifth operator condition” may be whether the eyes of the operator(s) are open; and a “sixth operator condition” may be whether the operator(s) are avoiding unwanted or unsafe behavior (e.g., smoking or other unwanted or unsafe activities) while operating the lift device. It should be appreciated that these operator conditions are provided as examples and are not meant to be limiting.

At step 1006, the controller determines whether one or more of the preset operator conditions are met (e.g., presence of an operator in the cab, seatbelt use, looking in the direction of travel, PPE use, lifting correctly, eyes open, avoiding unwanted or unsafe behavior, etc.). In some embodiments, all of the preset operator conditions must be met before a user may operate (e.g., move, lift, shift, activate, etc.) the industrial equipment. In other embodiments, only a subset of the preset operator conditions must be met before a user may operate the industrial equipment. The subset may be predetermined based on a manual selection (e.g., user selections transmitted to the controller, etc.) or an automatic selection of the conditions. The controller may determine whether the one or more operator conditions are met based on data from sensors disposed on the industrial equipment. For example, the controller may detect operator conditions based on data transmitted by optical sensors, one or more cameras, actuator sensors, weight sensors, seat switches, and the like. The controller may detect one or more operator conditions both inside and outside of the user-operated industrial equipment.

For example, to detect the first operator condition, the controller may perform image recognition to separate each of the operators'bodies into segments (e.g., lower limbs, torso, arms, head/neck, etc.) to determine whether seatbelts are being properly worn. In some examples, the controller receives a model seatbelt position relative to a model operator (e.g., from a fleet manager, from a provider of the industrial equipment, etc.). In such an example, the controller may determine whether seatbelts are being worn properly by comparing the position of the operators'seatbelts to the model seatbelt position. The controller may perform similar processes to detect whether each operator is wearing required PPE for detecting the third operator condition.

To detect the second operator condition, the controller may receive, from a user interface, a command to move the equipment in a particular direction. The controller may receive image data from a camera (e.g., the camera 300) indicative of the head and/or eye position of the operator and determine, based on the head and/or eye position of the operator, a field of view of the operator and whether the operator is looking in the direction of travel associated with the command. Similarly, the controller may determine, based on the image data, whether the operator's eyes are open for detecting the fifth operator condition.

To detect the fourth operator condition, the controller may receive, from the one or more cameras, image data regarding the position of the equipment while the lift device is lifting an object. The lifting positions may be compared to model lifting positions to determine whether the objects are being lifted correctly. Additionally or alternatively, the controller may determine whether objects are being lifted correctly based on sensor data received from lifting actuators associated with the equipment (e.g., the actuators 34a, 34b, 34c, 34d).

To detect the sixth operator condition, the controller may receive, from the one or more cameras, image data regarding the operator while the operator is operating the lift device. In some instances, the controller may receive various example images of lift device operators or other humans generally smoking or performing other unwanted or unsafe activities while operating lift devices, vehicles, or various other types of machinery (e.g., from a fleet manager, from a provider of the industrial equipment, etc.). Accordingly, the image data associated with the operator may be compared to the example images by the controller to determine whether the operator is avoiding unwanted or unsafe behavior while operating the lift device.

Upon determining that the one or more operator conditions are met for the equipment, the controller proceeds to step 1010, where the equipment is allowed to proceed with unrestricted, normal, or regular operation (e.g., performance or functions of the equipment is not limited, no warnings are provided to the operator, etc.). However, upon determining that the one or more operator conditions are not met, the controller proceeds to step 1008.

At step 1008, the controller is configured to perform an action responsive to determining that one or more operator conditions are not met. The action may include inhibiting the equipment from moving or reversing prior movements of the equipment. Additionally or alternatively, the action may include providing a notification to an onboard user interface (e.g., the user interface 20, etc.) or other onboard display regarding the operator conditions (e.g., what condition is not met, what action should be taken, what operational limitation(s) will be imposed, etc.). The action may include activating an alarm (e.g., the alarm 210). In some examples, the action performed by the controller is based on the type of operator conditions that are not met.

By way of example, if the controller detects that an operator's eyes are closed, the controller may activate an auditory alarm. The controller may additionally inhibit movement or operation of the equipment responsive to determining that an operator's eyes are closed (e.g., by operating a brake system, by preventing operation of the prime mover 41/motors 26, 52, by preventing operation of the actuators 34a, 34b, 34c, 34d, 35, etc.). As another example, if the controller detects that an operator's seatbelt is not being worn or is being worn improperly, or an operator is not wearing PPE, the controller may transmit a notification to the onboard user interface (e.g., the user interface 20, etc.) or other onboard display. In some examples, the notification may include the position of the operator who is not wearing/improperly wearing a seatbelt or PPE. If the controller detects that the user is not looking in the direction of where the lift device is traveling or will travel, the controller may stop or prevent movement of the lift device until the operator looks in the direction where the lift device is traveling or will travel. The controller may detect conditions outside of the workspace (e.g., the platform assembly 16, the cabin 88, away from the lift device, etc.), for example, if users are running in designated walking areas. If the controller detects that a user is running in a designated walking area, the controller may activate an audial-visual alarm (e.g., the alarm 210), according to an example.

As another example, the camera 300 may be positioned within a designated operator area, such as the cabin 88 of the lift device 10, where an operator must be present in order to perform lift functions (e.g., raising and lowering the platform 16, raising or lowering the implement 90, etc.). The camera 300 transmits image data to the controller 38 indicative of the presence of an operator or operators within the designated operator area. The controller 38 may, upon receiving a command/input (e.g., via the user interface 20, 21) to perform lift functions, perform image recognition on the image data to determine whether an operator is present in the designated operator area. If no operator or an improper number of operators are present in the designated operator area, then the controller 38 may inhibit certain operating functions. For example, if no operators or an improper number of operators are present in the cabin 86 of the lift device 10, then the controller 38 may inhibit lifting/lowering of the implement 90 and/or movement of the tractive elements 82. In this way, if an operator attempts to lift or lower the implement 90 from a position outside the designated operator area (e.g., while standing outside the cabin 86, etc.) then the controller 38 inhibits such lifting and lowering of the implement 90. In some examples, the controller 38 may further activate the alarm 210 (e.g., to sound a warning, to display a warning, flash a light, etc.) in response to an operator attempting to perform a task, such as lifting and lowering the implement 90, from a position outside the designated operator area.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift device 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A lift device comprising:
a chassis;
a platform configured to support a user;
a lift assembly coupling the platform to the chassis;
an actuator configured to at least one of (a) move the platform relative to the chassis or (b) propel the chassis;
a camera having a field of view and coupled to the platform; and
a controller configured to:
receive, from the camera, image data indicative of the field of view of the camera;
determine that a portion of the user extends within a predetermined area of the field of view of the camera; and
operate the actuator in response to determining that the portion of the user extends within the predetermined area.

2. The lift device of claim 1, wherein determining that the portion of the user extends within the predetermined area comprises determining that the portion of the user covers a threshold portion of the predetermined area.

3. The lift device of claim 2, wherein the threshold portion of the predetermined area is 40% of the predetermined area.

4. The lift device of claim 1, wherein the controller is further configured to:
determine that the portion of the user that is within the predetermined area includes a torso of the user,
wherein the actuator is operated in response to determining that the portion of the user extends within the predetermined area and that the portion of the user that is within the predetermined area includes the torso of the user.

5. The lift device of claim 4, wherein the controller is further configured to permit regular operation of the lift device in response to determining that the portion of the user that is within the predetermined area is an arm of the user.

6. The lift device of claim 1, wherein operating the actuator comprises at least one of (a) stopping movement of the actuator or (b) changing a direction of movement of the actuator.

7. The lift device of claim 1, wherein the controller is configured to operate an alarm in response to determining that the portion of the user is within the predetermined area.

8. The lift device of claim 1, wherein the controller is configured to:
determine that an obstacle is within the predetermined area; and
operate the actuator in response to determining that the obstacle is within the predetermined area.

9. A control system for user-operated industrial equipment, comprising:
a camera coupled to the user-operated industrial equipment; and
a controller communicatively coupled to the camera and configured to:
receive one or more operator conditions;
receive, from the camera, visual data indicative of the one or more operator conditions;
determine, based on the visual data, whether each of the one or more operator conditions are met;
inhibit operation of the industrial equipment in response to determining that at least one of the one or more operator conditions are not met; and
permit regular operation of the industrial equipment in response to determining that each of the one or more operator conditions are met.

10. The control system of claim 9, wherein the control system is further configured to operate an alarm in response to determining that the at least one of the one or more operator conditions are not met.

11. The control system of claim 9, wherein the control system is configured to, in response to determining that the at least one of the one or more operator conditions are not met, operate a user interface to display a notification regarding the at least one of the one or more operator conditions that are not met.

12. The control system of claim 9, wherein the one or more operator conditions include at least one of an operator (a) wearing personal protective equipment, (b) wearing a seatbelt, (c) wearing a harness, (d) looking in a direction in which the industrial equipment is moving, or (e) having open eyes.

13. The control system of claim 9, wherein the controller is further configured to:
receive, from the camera, visual data indicative of whether an operator is present within a designated operator area;
determine, based on the visual data, whether the operator is present within the designated operator area;
inhibit operation of the industrial equipment in response to determining that the operator is not present within the designated operator area; and
permit regular operation of the user-operated industrial equipment in response to determining that the operator is present within the designated operator area.

14. A method of controlling a lift device, comprising:
providing a camera having a field of view and coupled to a platform of the lift device, the platform configured to support a user;
receiving, from the camera, image data indicative of the field of view of the camera;
determining that a portion of the user extends within a predetermined area of the field of view of the camera; and
operating the lift device in response to determining that the portion of the user extends within the predetermined area.

15. The method of claim 14, wherein determining that the portion of the user extends within the predetermined area comprises determining that the portion of the user covers a threshold portion of the predetermined area.

16. The method of claim 14, further comprising:
determining that the portion of the user that is within the predetermined area includes a torso of the user,
wherein the lift device is operated in response to determining that the portion of the user that is within the predetermined area includes torso of the user.

17. The method of claim 14, further comprising:
permitting regular operation of the lift device in response to determining that the portion of the user that is within the predetermined area is an arm of the user.

18. The method of claim 14, wherein operating an actuator comprises stopping movement of the lift device.

19. The method of claim 14, wherein operating an actuator comprises changing a direction of movement of the lift device.

20. The lift device of claim 14, further comprising:
determining that an obstacle is within the predetermined area; and
operating an actuator of the lift device to stop movement of the lift device or change a direction of movement of the lift device in response to determining that the obstacle is within the predetermined area.
